(19) United States
(12) Patent Application Publication
(10) Pub. No.: US 2026/0084337 A1
(43) Pub. Date: Mar. 26, 2026

(54) HANDLE FOR A SAW, A SAW COMPRISING THE SAME, A SAW BLADE, AND A SAW SYSTEM

(71) Applicants: APACHE LTD, Beaconsfield, Buckinghamshire (GB); RE-VERB DESIGN LIMITED, Walthamstow, London (GB)

(72) Inventors: Scott RAMPLING, Enfield, Middlesex (GB); David TOWNSEND-ELLIOTT, Walthamstow, London (GB); Chris DOLAN, Walthamstow, London (GB)

(21) Appl. No.: 19/109,463

(22) PCT Filed: Jul. 13, 2023
(86) PCT No.: PCT/GB23/51839

§ 371 Date: Mar. 6, 2025

(30) Foreign Application Priority Data
Sep. 9, 2022 (GB) 2213196.5

(51) Int. Cl. B27B 21/04; B25G 1/01; B25G 3/24; B27B 33/10

(52) U.S. Cl. CPC B27B 21/04; B25G 1/01; B25G 3/24; B27B 33/10

(57) ABSTRACT

A handle for a saw includes a handle portion and a clamp. The handle portion and/or the clamp includes one or more locating members for locating with one or more corresponding cut-outs in a saw blade. The clamp is arranged for clamping the blade against the handle portion. Further provided are a saw comprising the handle, a saw blade and a saw system.

The present disclosure relates to a saw handle, to a saw blade for detachably attaching to the handle, to a saw comprising the handle and blade, and to a modular saw system comprising the handle and a range of interchangeable blades. In particular, the handle allows for the tool free removal/swapping of saw blades.

Manual hand saws are used for cutting a range of materials on building projects. They are often low-cost items, costing less than £10 in the UK. They are frequently treated as disposable items, which are used for a short time, often a single project, before being discarded. Their low-cost results from a construction that renders them cheap to make but difficult to recycle. Often they comprise plastic handles that are not easily separated from metal saw blades, and they are simply thrown away with general building waste.

Prior attempts have been made to provide a saw handle that allows for the removal/replacement of a saw blade, but these have not proved popular owing to their high cost, and a typically bulky and/or heavy construction.

The present invention arose in a bid to provide an improved saw handle with a lightweight, low-cost construction, which would allow for the removal/replacement of the saw blade.

Representative features are set out in the following clauses, which stand alone or may be combined, in any combination, with one or more features disclosed in the text and/or drawings of the specification.

According to the present invention in a first aspect, there is provided a handle for a saw, which comprises a handle portion and a clamp, wherein the handle portion and/or the clamp comprises one or more locating members for locating with one or more corresponding locating cut-outs in a saw blade, and the clamp is arranged for clamping the blade against the handle portion.

The present arrangement allows for a simple and low-cost, yet robust, construction, which firmly holds a saw blade during use, and allows for quick removal/replacement of the saw blade.

There are numerous benefits provided. These include, but are not limited to, positive savings for retailers particularly in terms of warehouse space and overall logistic fuel savings-meaning significant reduction in carbon emissions the space taken up by a stack of replaceable blades is far smaller than a stack of the same number of conventional saws. A far greener system is provided.

Moreover, the saw blade, once removed, may be recycled if it has reached the end of its life. The handle may be re-used.

Furthermore, the structure of the handle lends itself to a low part count construction that may be readily disassembled and recycled at the end of its life. It may consist of only the handle portion, clamp and a pin. The handle portion and the clamp may both be unitarily formed, preferably moulded from plastic. This provides three parts only for the construction of the handle. Disassembly, for recycling, or otherwise, will require only the removal of the pin to separate the handle into its three constituent parts. The disassembly/recycling may be further aided by the provision of an opening/void in the handle into which an end of the pin projects. The void being open at a surface of the handle and extending at an angle to the axis of the pin, preferably substantially orthogonal thereto. With the insertion of the tip of a tool, such as a flat head screwdriver for example, the pin may be pushed/levered out.

Moreover, as discussed below, a modular saw system may be provided that comprises a number of different, swappable, blades and a single handle.

There may be a single locating member or a plurality of locating members. The locating member(s) may comprise one or more bosses.

The single locating member or one or more or all of the plurality of locating members may have a non-circular profile.

The profiles of the one or more locating members and the one or more corresponding cut-outs are preferably substantially congruent.

When one or more of the locating members and one or more or the corresponding recesses of the saw blade have profiles that are substantially congruent then, when they are located with one another, movement of the saw blade in a plane of the saw blade will be substantially prevented by such location alone. The same applies with a single non-circular locating member that is substantially congruent with a corresponding recess.

Each of the locating members may comprise an overhang. The overhang is preferably arranged to overlap a portion of the blade immediately adjacent a corresponding one of the cut-outs in the saw blade. The overhang may be formed by an enlarged head of the locating member or a cutout in a side surface of the locating member. The overhang is preferably spaced from a base of the locating and/or a surface from which the locating member projects by a distance that is substantially equal to a thickness of the blade.

There may be one or more secondary locating members provided for locating with one or more corresponding secondary locating cut-outs in the saw blade. The secondary locating members may comprise bosses. The secondary locating members may have a reduced depth and/or smaller profile compared to the locating members.

The handle portion may comprise the one or more secondary locating members and the flap may comprise the one or more locating members, or the flap may comprises the one or more secondary locating members and the handle portion may comprise the one or more locating members.

The handle portion may comprise the one or more secondary locating members and the flap may comprise one or more recesses for receiving the one or more secondary locating members when the flap is closed, and/or the flap may comprise the one or more secondary locating members and the handle portion may comprise one or more recesses for receiving the one or more secondary locating members when the flap is closed.

The clamp preferably comprises a flap. The flap may be pivotally connected to the handle portion. It may pivot about an axis that is substantially parallel to a plane of the blade. It is preferably hinged to the handle portion. When the flap is open it may expose an open/substantially unobstructed face of the handle portion against which the saw blade is clamped by the clamp. When the flap is open it may expose the one or more locating members. The flap is preferably arranged such that the saw blade is sandwiched between the flap and the handle portion. When the handle portion comprises the one or more bosses, the flap may comprise one or more recesses for receiving the one or more bosses when the flap is closed. Alternatively, when the flap comprises the one or more bosses, the handle portion may comprises one or more recesses for receiving the one or more bosses when the flap is closed. As a further alternative these two alternatives may be combined with both the flap and handle portion comprising one or more bosses and one or more recesses. Preferably, the profiles of the one or more recesses and the one or more bosses are substantially congruent. The one or more recesses may be provided in opposed bosses.

A biasing means may be provided for biasing the flap towards a closed position. The biasing means may comprise a spring.

The clamp preferably comprises a clamping means for applying and/or maintaining a clamping force against the blade by the clamp. The clamping means may be arranged for linear or rotary engagement with the handle portion. The clamping means may comprise a clip, a catch, a latch, a threaded fastener, or otherwise.

The handle portion preferably comprises a grip portion and an adjacent elongate through hole for receiving a user's fingers in use.

One or both of the end portions of the grip portion, may have an enlarged rounded/curved form. Either of both end portions may be bulbous. Such sculpted profiles provide increased comfort when using the saw/handle in various orientations.

One or both of the end portions of the grip portion may be provided with through openings. These openings assist in offering shock absorption when the handle is dropped.

The handle portion may be unitarily formed. The handle portion is preferably formed from plastic. One or more hand grips may be removably attached to the grip portion, which may be formed from a different material to the handle portion. The hand grip(s) may be formed from rubber or wood, for example.

The handle portion preferably further comprises one or more recesses for receiving one or more corresponding tabs on the saw blade. The one or more recesses may be arranged to extend substantially perpendicular to a projection direction of the one or more locating members. The one or more recesses may comprise one or more slots in the handle portion.

When the one or more tabs of the saw blade are received by the one or more recesses of the handle, there is a further barrier to movement of the saw blade in a plane of the saw blade, and with the recesses perpendicular to the projection direction of the locating members, there is a restriction of the movement of the saw blade in the projection direction.

The handle may comprise one or more alignment members for locating with one or more corresponding alignment cut-outs in an edge of the saw blade. The one or more alignment members may comprise bosses. The one or more alignment members may be elongate. The one or more alignment members may be provided adjacent to the one or more recesses.

Internal clamping surfaces of the handle and clamp are preferably configured such that contact with the blade face is intermittent. The surfaces may be defined by a number of raised blade support portions/members, which are spaced from one another.

According to the present invention in a further aspect, there is provided a saw, which comprises a handle according to any of the above statements and a saw blade.

The saw is preferably a manual hand saw.

The one or more cut-outs in the saw blade are preferably spaced inwardly from a periphery of the saw blade. The one or more cut-outs preferably define closed openings.

As discussed above, it is preferable that the profiles of one or more or all of the one or more locating members and the profile of one or more or all of the one or more corresponding cut-outs are substantially congruent.

The tabs on the saw blade preferably protrude from an edge of the blade. They preferably protrude from a rear edge of the saw blade. The saw blade is preferably substantially planar. The tabs are preferably substantially co-planar with a remainder of the saw blade. The tabs may be formed by cut-outs in the saw blade.

The one or more secondary locating cut-outs in the saw blade may be spaced inwardly from a periphery of the saw blade and define closed openings and/or may be provided on the periphery of the saw blade and are open at the periphery.

The secondary locating members may have a reduced profile compared to the locating members.

The alignment cut-outs may be provided at a periphery of the saw blade and be open at the periphery.

The one or more alignment cut-outs may comprise slots.

The one or more alignment cut-outs may be provided in the edge of the blade from which the tabs protrude.

The blade may comprise a cutting edge comprising a plurality of teeth and an opposed top edge, wherein a finger grip is provided proximal the top edge, which comprises a cut-out.

The finger grip may be spaced inwardly from a periphery of the saw blade. The finger grip may be proximal an end of the blade which engages the handle. The finger grip may be adjacent the handle. The finger grip may be elongate. The finger grip may have curved or rounded ends.

According to the present invention in a further aspect, there is provided a saw blade comprising a first end portion for detachably connecting to a saw handle, a cutting edge extending between the first end portion and a second end portion, and a top edge opposed to the cutting edge, wherein the first end portion comprises one or more cut-outs for engaging with one or more corresponding locating members of the handle.

Preferably, a finger grip is provided proximal the top edge.

The finger grip may be spaced inwardly from a periphery of the saw blade. The finger grip may be proximal the first end portion. The finger grip may be elongate. The finger grip may have curved or rounded ends.

The one or more locating cut-outs in the saw blade may be spaced inwardly from a periphery of the saw blade. The one or more locating cut-outs may define closed openings. At least one of the one or more locating cut-outs may be non-circular.

One or more tabs may be provided on the saw blade, which protrude from an edge of the blade in the first end portion. The tabs may be substantially co-planar with a remainder of the saw blade. One or more alignment cut-outs may be provided in the edge of the blade from which the tabs protrude, which alignment cut-outs are open at the edge. The one or more alignment cut-outs may comprise slots.

According to the present invention in a yet further aspect, there is provided a saw system, which comprises a saw as claimed in any of the above statements and one or more further saw blades. Preferably at least two of the saw blades are different to one another.

Non-limiting embodiments of the invention will now be discussed with reference to the following drawings:

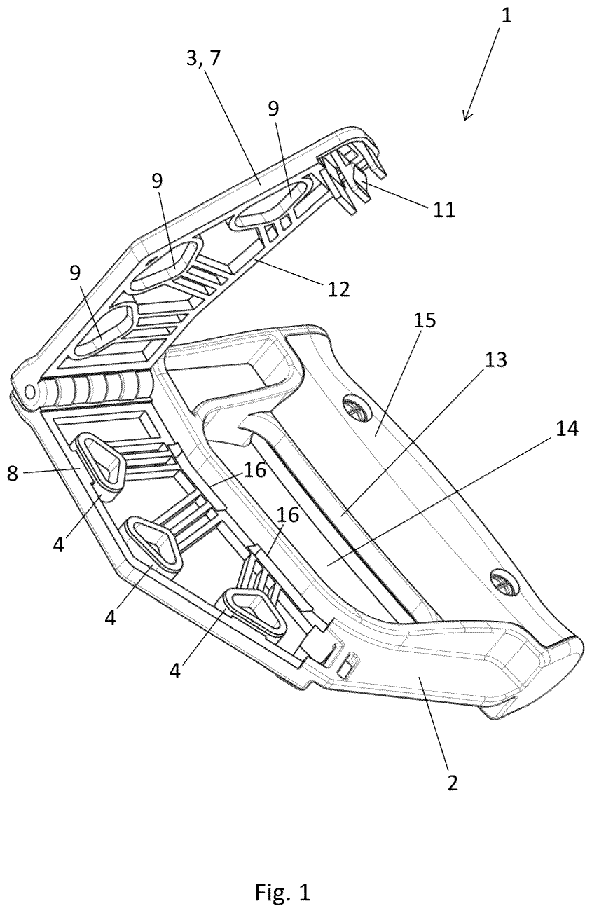

FIG. 1 is a perspective view of a handle according to a first arrangement in an open position;

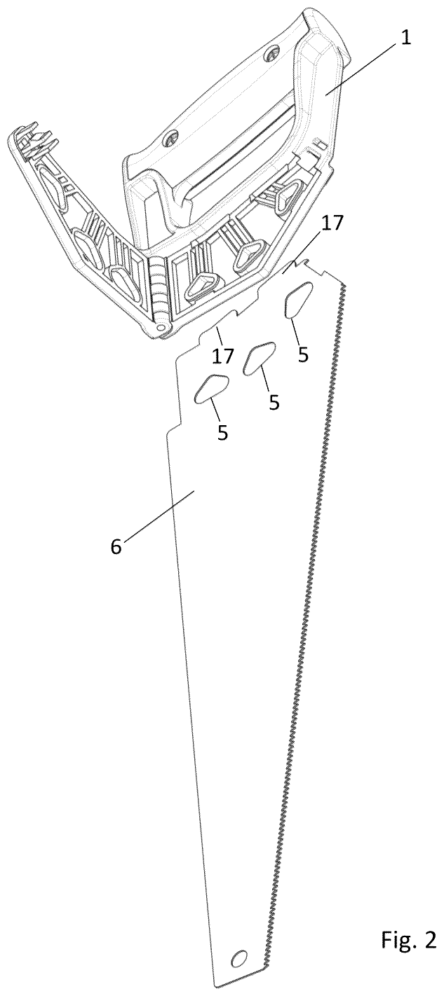

FIG. 2 is a perspective view of a combination of the handle of FIG. 1 and a saw blade for engagement therewith;

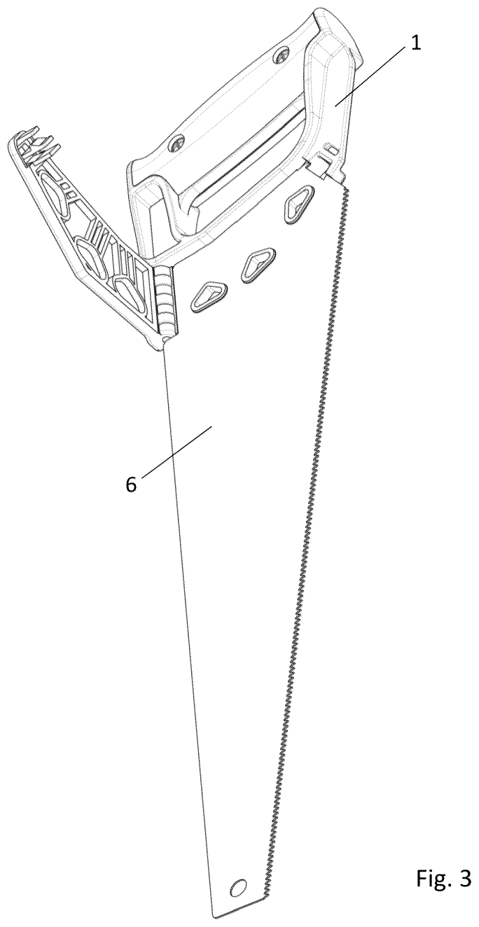

FIG. 3 is a perspective view of the combination of FIG. 2 showing the saw blade engaged with the handle and a clamp open;

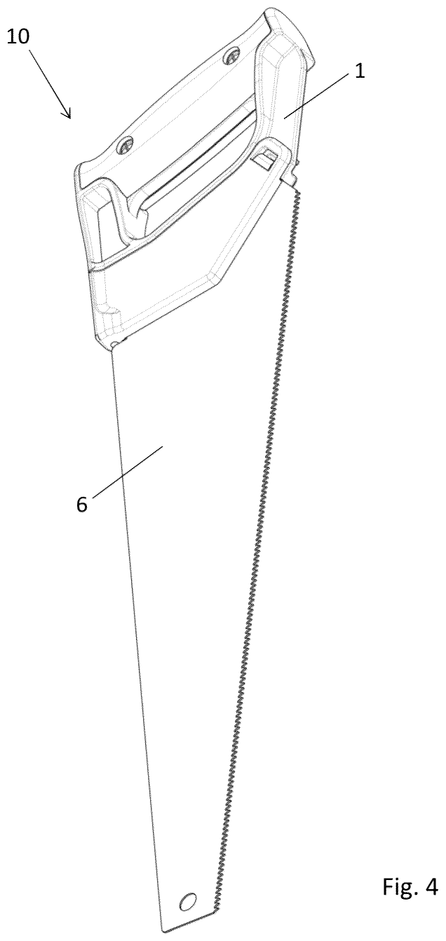

FIG. 4 is a perspective view of the combination of FIG. 3 with the clamp of the handle closed to provide a saw ready for use;

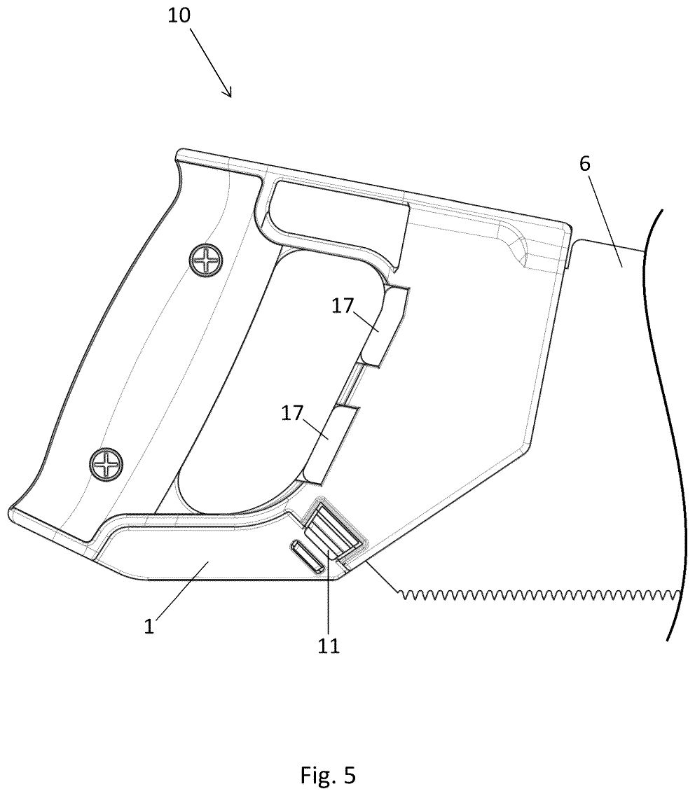

FIG. 5 is a close-up partial rear view of the saw of FIG. 4, showing the handle;

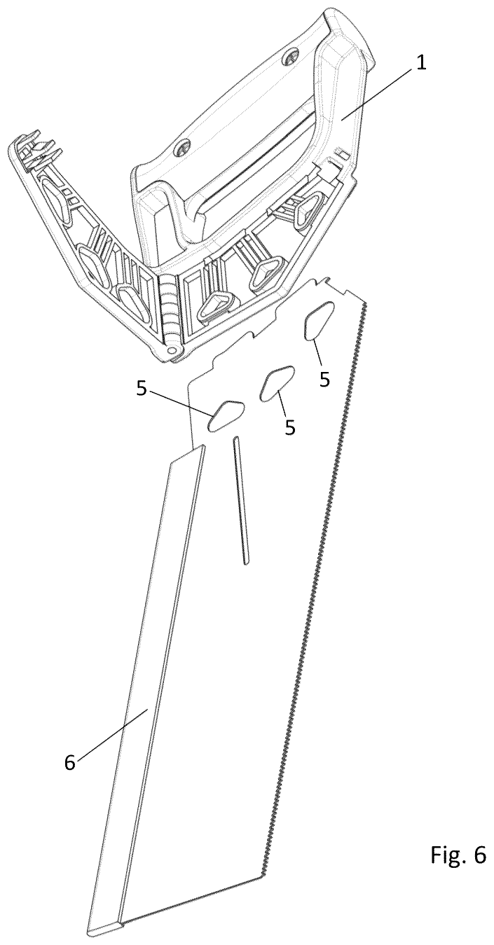

FIG. 6 is a perspective view of a combination of the handle of FIG. 1 and an alternative saw blade for engagement therewith;

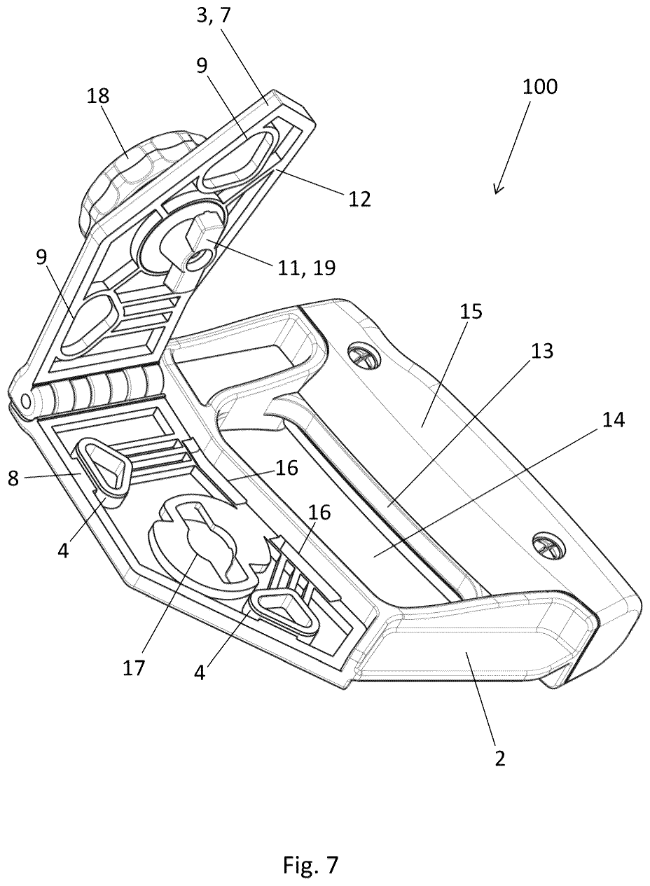

FIG. 7 is a perspective view of a handle according to a second arrangement in an open position;

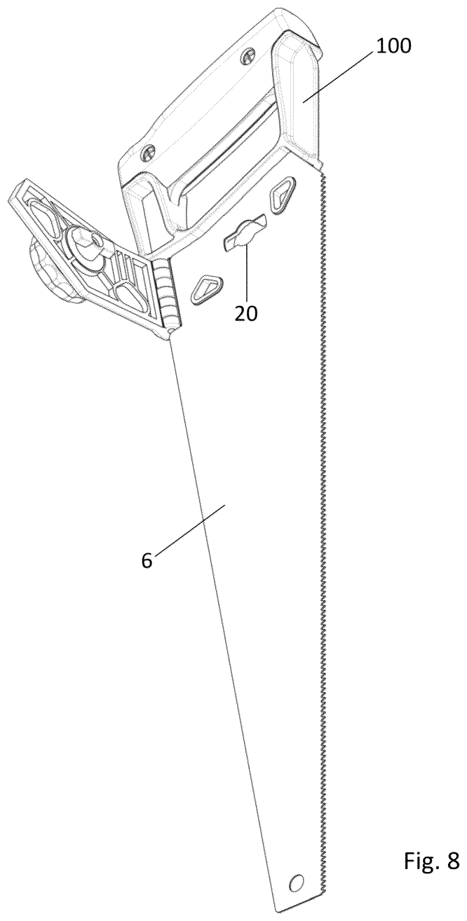

FIG. 8 is a perspective view of a combination of the handle of FIG. 7 with a saw blade for engagement therewith showing the saw blade engaged with the handle and a clamp open;

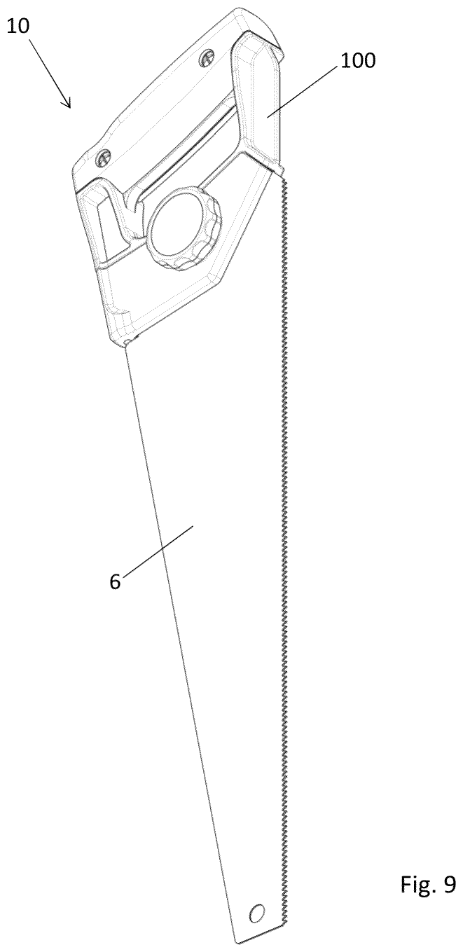

FIG. 9 is a perspective view of the combination of FIG. 8 with the clamp of the handle closed to provide a saw ready for use;

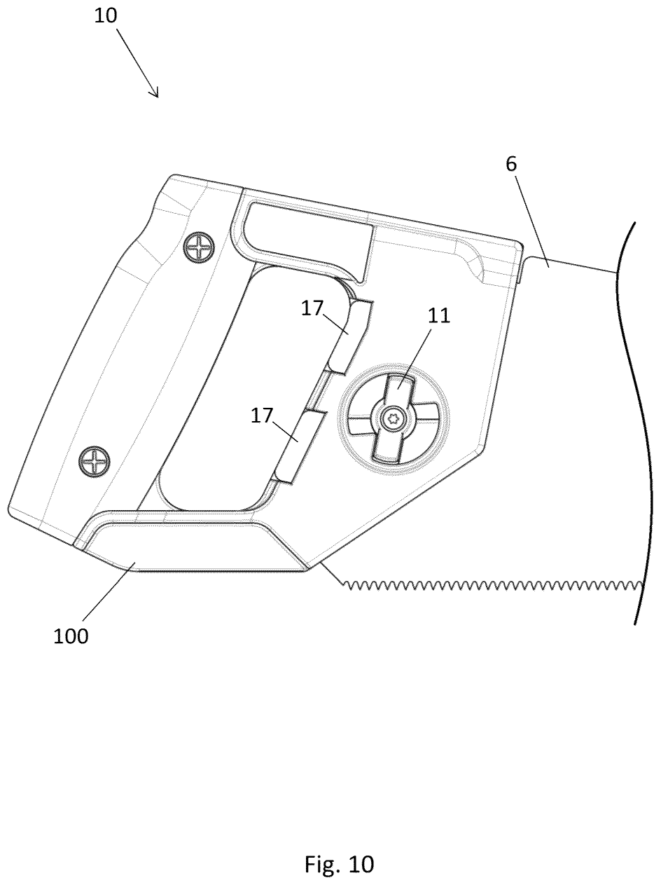

FIG. 10 is a close-up partial rear view of the saw of FIG. 9, showing the handle;

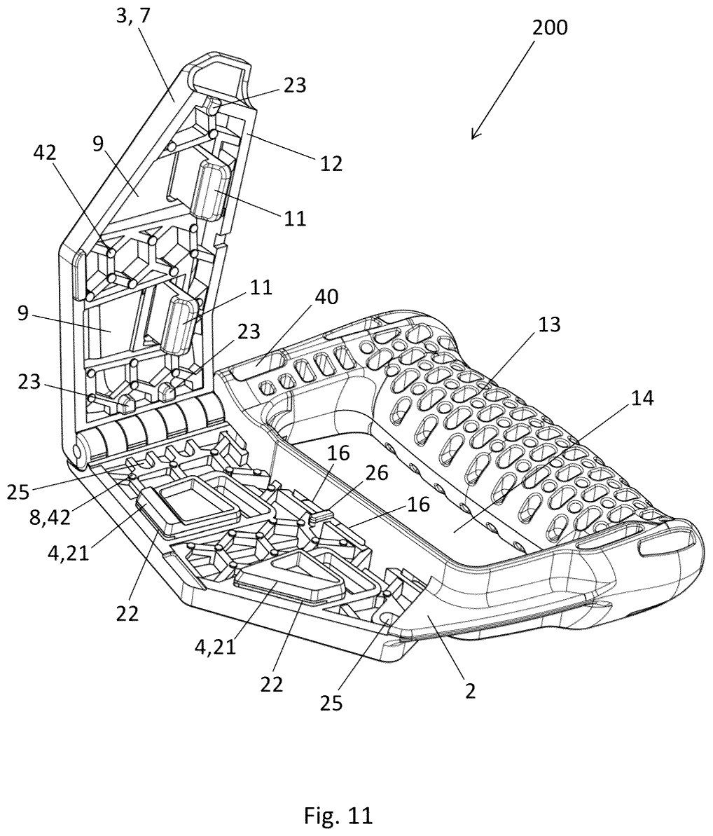

FIG. 11 is a perspective view of a handle according to a third arrangement in an open position;

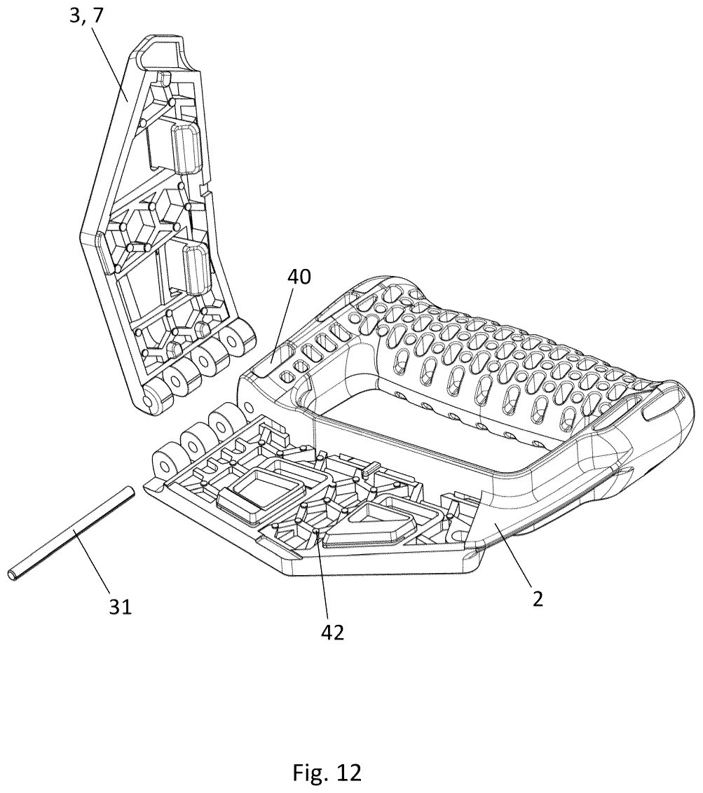

FIG. 12 is an exploded perspective view of the handle of FIG. 11, which shows the component parts separated;

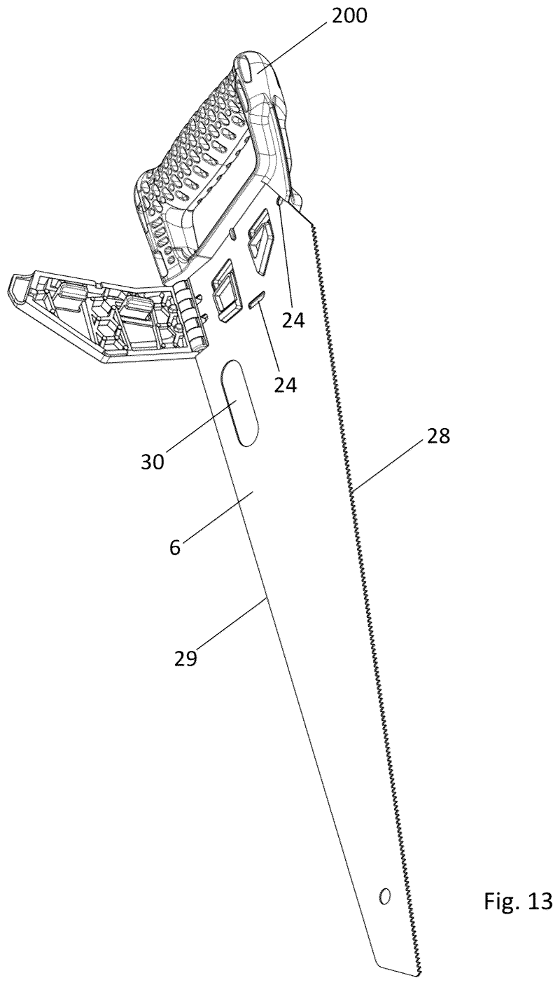

FIG. 13 is a perspective view of a combination of the handle of FIG. 11 and a saw blade engaged with the handle, with the clamp open;

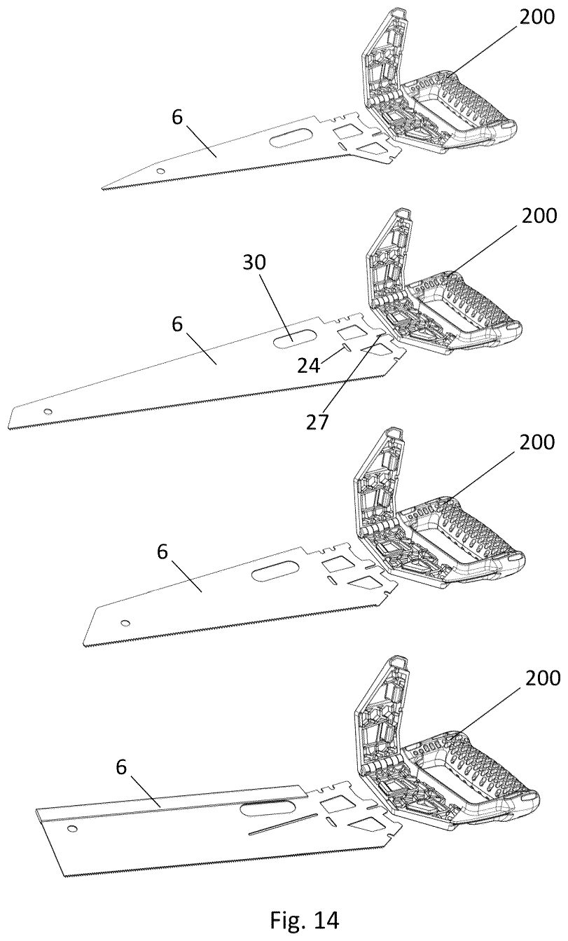

FIG. 14 shows four different saw blades in perspective view, each saw blade is shown adjacent a common handle in the open position;

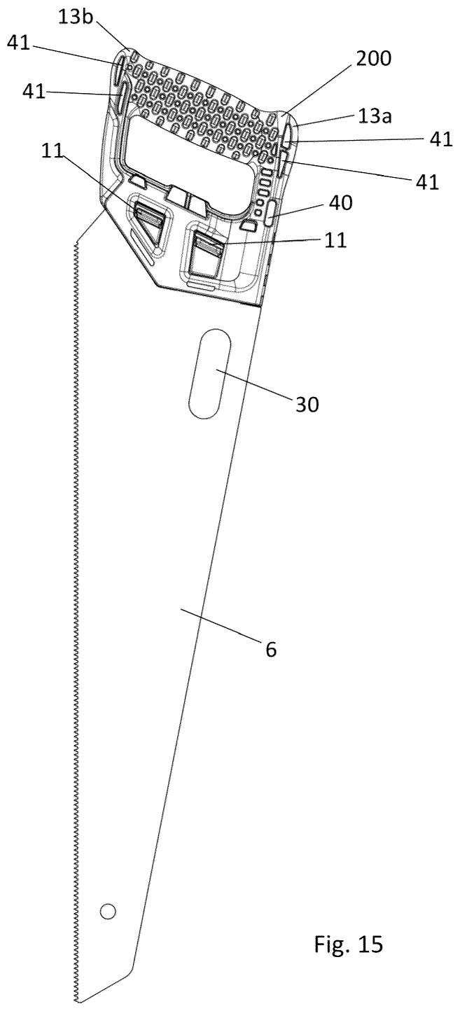

FIG. 15 shows a rear view of the combination of FIG. 13 with the clamp of the handle closed to provide a saw ready for use.

There is provided a handle 1, 100, 200 for a saw 10, which handle 1, 100 comprises a handle portion 2 and a clamp 3, the handle portion 2 and/or the clamp 3 comprises one or more locating members 4 for locating with one or more corresponding cut-outs 5 in a saw blade 6, and the clamp 3 is arranged for clamping the saw blade 6 against the handle portion 2.

FIGS. 1 to 6 show a handle 1 according to a first arrangement. FIGS. 7 to 10 show a handle 100 according to a second arrangement. FIGS. 11 to 15 show a handle 200 according to a third arrangement.

It is to be noted that in the depicted arrangements, the locating members 4 comprise bosses. This need not be the case in alternative arrangements, as discussed below. Moreover, in the depicted arrangements, the locating members 4 are provided on the handle portion 2 (and optional corresponding recesses 9 are provided on the clamp 3). In alternative arrangements (not shown) the one or more locating members 4 could be provided on the clamp 3 instead (optionally with corresponding recesses 9 provided on the handle portion), or one or more locating members (and optionally one or more recesses) could be provided on both the handle portion 2 and the clamp 3. Discussion related to the bosses 4 below may be applied more generally to alternatively formed locating members, as will be appreciated by those skilled in the art. The disclosed arrangements comprise non-limiting examples only.

The handles of the described first and second arrangements are of very similar construction to one another. They differ primarily in respect of their clamping means 11. The handle of the third arrangement has much in common with the first and third arrangements, being closer to the first arrangement in respect of its clamping means, but features several modifications. The discussion below will focus on the first arrangement. Discussion of the second and third arrangements will be focused on the differences, so as to avoid repetition. Like numbering will be used between the arrangements. It should be appreciated that the discussion of the first arrangement, its features, and possible modifications, will be directly applicable to the second and third arrangements, and vice versa, as will be immediately evident to those skilled in the art. Moreover, a feature or combination of features described in respect of one arrangement may be integrated into any of the other arrangements. The arrangements are not limiting in this regard.

Considering the first arrangement of FIGS. 1 to 6, by way of example only, three bosses 4 are provided as the locating members. It should be appreciated that in alternative arrangements, there may be more or less bosses 4 provided. There could be a single boss 4 provided. References herein to one or more or all of the bosses are intended to cover both arrangements with a plurality of bosses and arrangements with a single boss.

One or more or all of the bosses 4 may have a non-circular profile although this need not be the case. One or more or all of the bosses could have a circular profile.

One or more or all of the bosses 4 may be substantially congruent with corresponding cut-out(s) in the blade, as shown.

In the present arrangement, by way of example only, all of the bosses 4 are non-circular. They are substantially triangular. However they need not be limited as such.

One or more or all of the bosses 4 may have straight or curved sides, or a combination of the two, they may be regular or irregular in form, they may be substantially square, rectangular, oval, circular or otherwise, they may be differently sized and/or shaped to one another, or they may be the same size and/or shape as one another.

One or more or all of the bosses 4 may have substantially parallel or tapered side wall(s).

In the event a single boss 4 is provided, which is non-circular and substantially congruent with a corresponding cut-out in the saw blade 6, movement of the blade in the plane of the saw blade 6 will be substantially prevented by the boss locating with the cut-out alone. The same effect will be achieved with a plurality of bosses, irrespective of their shape. However, the effect may be enhanced by a plurality of non-circular bosses 4, which are substantially congruent with respective cut-outs in the saw blade 6, as is the case in the exemplary depicted arrangement, as best seen in FIG. 3.

The clamp 3 preferably comprises a flap 7. The flap 7 may be pivotally connected to the handle portion 2. It preferably pivots about an axis that is substantially parallel to a plane of the blade. It is preferably hinged to the handle portion, as shown, but may be otherwise connected. The handle 1 is preferably arranged such that when the flap is open it exposes an open/substantially unobstructed face 8 of the handle portion 2 against which the saw blade 6 is clamped by the clamp 3. The flap 7 is preferably arranged such that the saw blade is sandwiched between the flap and the handle portion. It is preferably sandwiched between the face 8 and a face 12 of the flap 7.

The bosses 4 preferably project beyond the face 8 by a greater distance than the thickness of the saw blade 6 to be attached to the handle 1, whereby the bosses 4 project through the cut-outs 5 in the saw blade 6 by a predetermined distance when the blade is seated, as best seen in FIG. 3.

The one or more cut-outs 5 in the saw blade 6 are preferably spaced inwardly from a periphery of the saw blade, as shown. The one or more cut-outs preferably define closed openings. However, in alternative arrangements, the cut-outs could extend to one or more edges of the saw blade 6 to locate with locating members 4 that may or may not comprise bosses.

The handle portion 2 preferably further comprises one or more recesses 16 for receiving one or more corresponding tabs 17 on the saw blade 6. The one or more recesses are preferably arranged to extend substantially perpendicular to a projection direction of the one or more bosses 4. The one or more recesses 16 preferably comprise one or more slots in the handle portion 2. In the present arrangement, by way of example only, two tabs 17 are provided on the blade 6 and two corresponding recesses 16, in the form of slots, are provided in the handle portion 2. The receipt of the tabs 17 by the recesses 16 is best seen in FIGS. 2 and 3 and in FIG. 5.

The tabs 17 on the saw blade 6 preferably protrude from an edge of the blade. They preferably protrude from a rear edge of the saw blade 6, as shown, but need not be limited as such. Tabs could protrude from one or more edges of the saw blade 6. The tabs may be formed by cut-outs in one or more edges of the blade. The saw blade 6 is preferably substantially planar, as again shown. The tabs 17 are preferably substantially co-planar with a remainder of the saw blade 6.

With the provision of one or more recesses 16 for receiving corresponding tabs 17 of the saw blade 6, there is a further barrier to movement of the saw blade 6 in a plane of the saw blade 6. Moreover, with the recesses 16 arranged perpendicular to the projection direction of the bosses 4, there is a restriction of the movement of the saw blade in the projection direction, even prior to clamping.

It must be noted, however, that whilst the disclosed arrangement comprises both the one or more recesses 16 and the one or more locating members 4, there may be arrangements that omit the one or more recesses 16. For example, in one alternative, the recesses 16 may be omitted from the handle 1 and the tabs 17 may be omitted from the blade, whilst one or more locating members 4, which comprise bosses or otherwise are maintained.

The flap 7 may comprise one or more recesses 9 for receiving the one or more bosses 4 when the flap 7 is closed. The recesses are recessed with respect to the face 12. The flap 7 is shown in a closed/clamped position in FIG. 4. There will typically be an equal number of recesses 9 to bosses 4, although this need not be the case. For example, there could be a single recess 9 that receives a plurality of the recesses 4. Moreover, the recess(es) 9 could be omitted. Preferably, the profiles of the one or more recesses 9 and the one or more bosses 4 are substantially congruent. By such an arrangement, relative movement between the flap 7 and the handle portion 2 in directions parallel to the plane of clamped saw blade 6 will be substantially eliminated. The one or more recesses may be provided in bosses on the flap 7 that are opposed to the bosses 4 on the handle portion 2, or vice versa.

A biasing means (not shown) may be provided for biasing the flap 7 towards the closed/clamped position. The biasing means may, for example, comprise a spring.

The clamp 3 preferably comprises a clamping means 11 for applying and/or maintaining a clamping force against the saw blade 6 by the clamp 3. The clamping means 11 need not be particularly limited in form, as will be readily appreciated by those skilled in the art. Various mechanisms may be implemented, as will be readily appreciated by those skilled in the art, which can be arranged for linear or rotary engagement with the handle portion 2, or otherwise. The clamping means may, for example, comprise a clip, a catch, a latch, a threaded fastener, or otherwise.

In the present arrangement, by way of example only, the clamping means 11 comprises a catch for engaging the handle portion 2. The catch may be received by a suitable opening in the handle portion 2. The rear view of FIG. 5 shows the catch engaged. The catch is preferably integrally formed with the flap 7. It may comprise a resilient finger. The catch preferably comprises a protrusion that forms a ramp, as seen in FIG. 1. With closure of the flap 7, the ramp will engage the handle portion 2. Engagement of the ramp with the handle portion 2 and continued closing of the flap 7 will cause the ramp to ride over an edge/wall/surface of the handle portion deflecting the catch until a point at which the wall/edge/surface is cleared by the ramp, at which point the catch will resile, locking the flap 7 in a clamping position.

Notably, whilst in the present arrangement the clamp 3 comprises a flap 7, this need not be the case in alternative arrangements. The flap 7 could be omitted. In such case, the clamp 3 could, for example, comprise one or more threaded clamping means, or otherwise.

The handle portion preferably comprises a grip portion 13 and an adjacent elongate through hole 14 for receiving a user's fingers in use.

The handle portion 2 may be unitarily formed. One or more hand grips 15 may be integrally formed with the handle portion 2 or may be separably formed and removably attached to the grip portion 13 of the handle portion 2. When removably attached hand grips 15 are provided they may be formed from a different material to the handle portion 13. The hand grips 15 may be formed from rubber or wood, for example.

In addition to greatly improving recyclability, the handles discussed herein, also allow for the swapping of blades. The swapping of blades is possible without use of a tool. A saw system may be provided comprising a saw handle and one or more saw blades. One or more of the saw blades may be different to one another, as shown, for example, in FIGS. 2 and 6.

With reference to FIGS. 7 to 10, the second arrangement will now be discussed.

By way of example only, two bosses 4 are provided as the locating members. It should be appreciated that in alternative arrangements, as discussed above, there may be more or less bosses 4 provided. There could be a single boss 4 provided. Any of the potential modifications in respect of the locating members 4, as discussed with respect to the first arrangement are applicable here.

As discussed, the primary difference between the second arrangement and the first arrangement is the clamping means 11. In the second arrangement in place of the (linear) catch of the first arrangement, there is provided a (rotary) latch. As with the first arrangement, the second arrangement need not be limited to this specific clamping means 11.

The latch preferably comprises a knob 18 for applying a turning force to the latch, as shown. The latch preferably comprises a catch 19 that is received by a suitable opening 17 in the handle portion 2, and a corresponding cut-out in the blade 6, as shown in FIG. 8. These both preferably have an elongate form as shown, to receive the catch 19 in an appropriate (unlocked) orientation. The rear view of FIG. 10 shows the catch engaged (following its locking rotation). The catch 19 preferably comprises a protrusion that may comprise a rib, as seen in FIG. 7. With closure of the flap 7, the catch will pass through both the cut-out 20 in the blade 6 and the opening 17 in the handle portion 5. Having passed through both, the catch 19 will be rotated by turning the knob 18. An upper surface of catch 19 will engage an opposed rear surface of the handle portion 2, which comprises a suitably configured ramp, or more preferably a pair of diametrically opposed ramps, as provided in the present arrangement. With the rotation of the catch 19 it will ride over the ramp, pulling down the clamp, until the protrusion on the clamp reaches a detent to lock the position of the catch 19 and the clamp 3 in a clamped position, as seen in FIG. 10.

With reference to FIGS. 11 to 15, the third arrangement will now be discussed. As discussed above, the discussion of the third arrangement focusses on the differences from the first and second arrangements. The discussion of common features/alternatives above is directly applicable to this arrangement, as will be readily appreciated by those skilled in the art. Moreover, the features discussed below may be incorporated into the first and/or second arrangement, as will be appreciated by those skilled in the art.

The handle of FIGS. 13 to 15 is preferably of three-part construction, consisting of the handle portion 2, the clamp 3 and a pin 31. The same three-part construction may be applied to at least the first arrangement also.

By way of example only, two bosses 4 are provided as the locating members. It should be appreciated that in alternative arrangements, as discussed above, there may be more or less bosses 4 provided.

The bosses 4 may take any arrangement/configuration as discussed above. The bosses 4 each comprise an overhang 21, as best seen in FIG. 11, which is configured to cover/overlap a portion of the saw blade 6 immediately adjacent the respective cut-out 5.

The overhang 21 may be formed by a cut-out 22 in each boss and/or an enlarged head of each boss, or otherwise. A blade engaging surface (i.e., a bottom surface) of the overhang is preferably spaced from a base of each boss/the face 8 by a distance that is substantially equal to a thickness of the saw blade.

The overhang 21 substantially prevents uplift of the blade (when in a seated position, as shown, for example, in FIG. 13) away from the handle portion even before the clamp 3 is closed.

In use (i.e. during sawing), the overhang, which lips over the blade cut outs, provides an anti-lift feature meaning the blade stays flat during the action of sawing (when the blade is flexing). This minimises any gapping between the blade and the handle. Moreover, the overhang also offers an intermediate fastening when the flap is open, which means the blade will not fall out inadvertently during a blade change operation.

One or more secondary locating members 23 may, optionally, be provided in addition to the (first) locating members 4, as shown. In such case one or more corresponding secondary locating cut-outs 24 will be provided in the saw blade, as also shown.

The secondary locating members 23 again preferably comprise bosses. Whilst not limited as such, the secondary locating members 23 may have a reduced depth and/or smaller profile compared to the locating members. In the depicted arrangement, they have both a reduced depth and a smaller profile.

Corresponding recesses 25 may, optionally, be provided for receiving the one or more secondary locating members 23. In the depicted arrangement, the handle portion 2 comprises the one or more secondary locating members 23 and the flap 7 comprises the one or more recesses 25 for receiving the one or more secondary locating members when the flap is closed. In alternative arrangements, the flap 7 may comprise the one or more secondary locating members 23 and the handle portion 2 may comprise the one or more recesses 25 for receiving the one or more secondary locating members 23 when the flap 7 is closed.

It is preferable, whichever of handle portion 2 or flap 7 comprises the one or more secondary locating members, the other of the handle portion 2 or flap 7 comprises the (first) locating members 4. In the depicted arrangement, the flap 7 comprises the one or more secondary locating members 23 and the handle portion 2 comprises the one or more locating members 4.

The secondary locating members 23, when provided, are arranged to engage with secondary locating cut-outs 24 in the saw blade 6, wherein the one or more secondary locating cut-outs 24 in the saw blade may be spaced inwardly from a periphery of the saw blade and define closed openings and/or be provided on the periphery of the saw blade and open at the periphery.

The handle may further comprise one or more alignment members 26 for locating with one or more corresponding alignment cut-outs 27 in an edge of the saw blade. The one or more alignment members 26 are preferably provided adjacent to the one or more recesses 16, as shown.

The one or more alignment members 26 preferably comprise bosses. The one or more alignment members 26 may be elongate, wherein the elongation may be aligned generally with an insertion direction of the blade, as shown.

The clamping means 11 for the third arrangement comprises a pair of catches for engaging the handle portion 2. The catches may be received by one or more suitable openings in the handle portion 2. Of course, a single catch, or alternatively configured clamping means, may be implemented, as will be appreciated by those skilled in the art.

As mentioned, any one or more of the features discussed with respect to the third arrangement, in particular, the one or more locating members comprising overhangs 21, the one or more secondary locating members 23, and/or the one or more alignment members 26 may be integrated into either of the first or second arrangements.

A further feature now discussed with reference to FIGS. 13 to 15 is the provision of a finger grip 30 in the blade. As should be appreciated, the provision of a finger grip 30 is not limited to any particular handle arrangement 1, 100, 200. A blade for use with any handle in accordance with the discussion above may be provided with a finger grip.

The finger grip is primarily a safety feature allowing the user to remove and load new blades without having to engage with or grip the sharp teeth. Saw blades are very sharp and unforgiving.

Considering the blades shown in FIGS. 13 to 15, and noting that FIG. 14 shows a range of alternative blade forms all suitable for attachment to a common handle, each blade comprises a cutting edge 28 comprising a plurality of teeth and an opposed top edge 29, wherein a finger grip 30 is provided proximal the top edge, which comprises a cut-out.

The finger grip 30 is preferably spaced inwardly from a periphery of the saw blade. The finger grip 30 is preferably proximal an end of the blade which engages the handle. The finger grip 30 is preferably adjacent the handle, as best shown in FIG. 15. The finger grip is preferably elongate. The finger grip preferably has curved or rounded ends.

The shape of the finger grip is not particularly limited, as will be appreciated by those skilled in the art. It will preferably be sized so that a user may insert two, three or more fingers (gloved or not) to enable the safe gripping of the blade during insertion or removal of the blade from the handle. It may be curved or straight. It may be profiled to generally conform a user's fingers. In the depicted arrangement it is substantially straight with round ends. It is preferably positioned closer to a rear of the blade that the front of the blade, as again shown, so as to aid in control of the blade during insertion/removal from the handle.

As is clear from FIG. 14, there may be provided a saw system a handle having any above described configuration and two or more saw blades, wherein at least two of the saw blades are different to one another.

Several additional features of the handle will now be discussed with respect to the handle 200. Again, whilst these features are discussed in respect of the handle 200, they may be incorporated into any of the other handle arrangements discussed.

There may be an opening/void 40 in the handle into which an end of the pin 31 projects. The void 40 is preferably open at an outer surface of the handle and extends at an angle to the axis of the pin 31, most preferably substantially orthogonal thereto. The void 40 may be a through opening. The void 40 may extend longitudinally along the axis of the pin 31. With the insertion of the tip of a tool, such as a flat head screwdriver for example, the pin 31 may be pushed/levered out, so as to allow for easy disassembly of the handle.

One or both of the end portions 13a, 13b of the grip portion 13, may have an enlarged rounded/curved form. They may be bulbous. This is best seen in FIGS. 11 and 15. Such sculpted profiles provide increased comfort when using the saw/handle in various orientations. Typical designs tend to have these ends as sharp features/protrusions, focusing on traditional look rather than its practical use. Saws are often used with both hands in multiple orientations and quite aggressively, particularly when stripping out (cutting branches or removing old PVC windows as two examples). The curved profiles offer increased comfort.

One or both of the end portions 13a, 13b of the grip portion 13 may be provided with through openings 41. These openings 41 are not particularly limited in shape and size. They have the benefit of reducing weight. Moreover, they assist in offering shock absorption when the handle is dropped. On conventional saws these are vulnerable/weak spots, and when dropped plastic constructed handles often shatter/break open.

The internal surfaces of the handle and clamp are preferably configured such that contact with the blade face is intermittent. The surfaces may be defined by a number of raised blade support portions/members 42, which are spaced from one another. Such an arrangement, allows a certain amount of nuisance dust/debris (associated with sawing) to be present without impacting on the closure. A cellular form of the handle and clamp, as seen in FIGS. 11 and 12, additionally/alternatively assists in this regard.

Numerous alternative arrangements and modifications to the handles as described herein will be readily appreciated by those skilled in the art within the scope of the appended claims.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

Although certain example embodiments of the invention have been described, the scope of the appended claims is not intended to be limited solely to these embodiments. The claims are to be construed literally, purposively, and/or to encompass equivalents.

We claim:

1. A handle for a saw, comprising:
a handle portion; and
a clamp,
wherein the handle portion and/or the clamp comprises one or more locating members for locating with one or more corresponding locating cut-outs in a saw blade, and the clamp is arranged for clamping the blade against the handle portion.

2. The handle for a saw as claimed in claim 1, wherein the one or more locating members comprise bosses.

3. The handle as claimed in claim 1, wherein the clamp comprises a flap.

4-5. (canceled)

6. The handle as claimed in claim 3, wherein the handle portion comprises the one or more bosses and the flap comprises one or more recesses for receiving the one or more bosses when the flap is closed, and/or wherein the flap comprises the one or more bosses and the handle portion comprises one or more recesses for receiving the one or more bosses when the flap is closed.

7. (canceled)

8. The handle as claimed in claim 1, wherein each of the locating members comprises an overhang.

9-11. (canceled)

12. The handle as claimed in claim 1, further comprising one or more secondary locating members for locating with one or more corresponding secondary locating cut-outs in the saw blade.

13-16. (canceled)

17. The handle as claimed in claim 3, further comprising a biasing means for biasing the flap towards a closed position.

18-19. (canceled)

20. The handle as claimed in claim 1, wherein the clamping means is arranged for linear or rotary engagement with the handle portion.

21. (canceled)

22. The handle as claimed in claim 1, wherein the handle portion comprises a grip portion and an adjacent elongate through hole for receiving a user's fingers in use.

23. (canceled)

24. The handle as claimed in claim 1, wherein the handle portion further comprises one or more recesses for receiving one or more corresponding tabs on the saw blade.

25-26. (canceled)

27. The handle as claimed in claim 1, further comprising one or more alignment members for locating with one or more corresponding alignment cut-outs in an edge of the saw blade.

28-30. (canceled)

31. A saw, comprising:
the handle as claimed in claim 1; and
a saw blade.

32. The saw as claimed in claim 31, wherein the one or more locating cut-outs in the saw blade are spaced inwardly from a periphery of the saw blade.

33-37. (canceled)

38. The saw as claimed in claim 31, wherein the handle further comprises one or more secondary locating members for locating with one or more corresponding secondary locating cut-outs in the saw blade, and wherein the one or more secondary locating cut-outs in the saw blade are spaced inwardly from a periphery of the saw blade and define closed openings and/or are provided on the periphery of the saw blade and are open at the periphery.

39-42. (canceled)

43. The saw as claimed in claim 31, wherein the blade comprises a cutting edge comprising a plurality of teeth and an opposed top edge, wherein a finger grip is provided proximal the top edge, which comprises a cut-out.

44-48. (canceled)

49. A saw blade, comprising:
a first end portion for detachably connecting to a saw handle,
a cutting edge extending between the first end portion and a second end portion, and
a top edge opposed to the cutting edge,
wherein the first end portion comprises one or more cut-outs for engaging with one or more corresponding locating members of the handle.

50-57. (canceled)

58. The saw blade as claimed in claim 49, further comprising tabs on the saw blade, which protrude from an edge of the blade in the first end portion.

59. (canceled)

60. The saw blade as claimed in claim 58, wherein one or more alignment cut-outs are provided in the edge of the blade from which the tabs protrude and are open at the edge.

61. (canceled)

62. A saw system, comprising:
a saw as claimed in claim 31; and
one or more further saw blades,
wherein at least two of the saw blades are different to one another.
